(19) United States
(12) Patent Application Publication
(10) Pub. No.: US 2021/0302089 A1
(43) Pub. Date: Sep. 30, 2021

(54) Inverter System For A Heating, Ventilation, And Air-Conditioning System

(71) Applicant: Goodman Global Group, Inc., Waller, TX (US)

(72) Inventor: Michael F Taras, The Woodlands, TX (US)

(73) Assignee: Goodman Global Group, Inc., Waller, TX (US)

(21) Appl. No.: 17/213,477

(22) Filed: Mar. 26, 2021

Related U.S. Application Data
(60) Provisional application No. 63/002,914, filed on Mar. 31, 2020.

(51) Int. Cl. F25B 49/02

(52) U.S. Cl. CPC F25B 49/022; F25B 2600/112; F25B 2600/111; F25B 2600/021

(57) ABSTRACT

A heating, ventilation, and air-conditioning (“HVAC”) system for use with a refrigerant. The HVAC system may include a compressor, a condenser, an expansion device, an evaporator, a variable speed inverter, and a fixed inverter. The compressor may be operable to compress the refrigerant. The condenser may be positioned downstream of the compressor and operable to condense the refrigerant. The expansion device may be positioned downstream of the condenser and operable to reduce a pressure of the refrigerant flowing therethrough. The evaporator may be positioned downstream of the expansion device and upstream of the compressor. The evaporator may be operable to vaporize the refrigerant from the expansion device. The variable speed inverter may be operable to deliver DC power to the compressor. The fixed inverter may be operable to deliver DC power to the compressor.

### BACKGROUND

This section is intended to provide relevant background information to facilitate a better understanding of the various aspects of the described embodiments. Accordingly, these statements are to be read in this light and not as admissions of prior art.

In general, heating, ventilation, and air-conditioning (“HVAC”) systems circulate an indoor space's air over low-temperature (for cooling) or high-temperature (for heating) sources, thereby adjusting an indoor space's ambient air temperature. HVAC systems generate these low- and high-temperature sources by, among other techniques, taking advantage of a well-known physical principle: a fluid transitioning from gas to liquid releases heat, while a fluid transitioning from liquid to gas absorbs heat.

Within a typical variable capacity HVAC system, a fluid refrigerant circulates through a closed loop of tubing that uses a compressor, which receives DC power from an inverter, and flow-control devices to manipulate the refrigerant's flow and pressure, causing the refrigerant to cycle between the liquid and gas phases. Generally, these phase transitions occur within the HVAC system heat exchangers, which are part of the closed loop and designed to transfer heat between the circulating refrigerant and flowing ambient air. As would be expected, the heat exchanger providing heating or cooling to the climate-controlled space or structure is described adjectivally as being “indoors,” and the heat exchanger transferring heat with the surrounding outdoor environment is described as being “outdoors.”

The refrigerant circulating between the indoor and outdoor heat exchangers, transitioning between phases along the way, absorbs heat from one location and releases it to the other. Those in the HVAC industry describe this cycle of absorbing and releasing heat as “pumping.” To cool the climate-controlled indoor space, heat is “pumped” from the indoor side to the outdoor side, and the indoor space is heated by doing the opposite, pumping heat from the outdoors to the indoors.

For both heating and cooling of indoor spaces, the inverter adjusts the DC voltage supplied to the compressor. However, inverters may overheat when the HVAC system is at full load conditions and is exposed to the extreme environments, causing the HVAC system to shut down when either heating or cooling is most needed.

### BRIEF DESCRIPTION OF THE DRAWINGS

Embodiments of the HVAC system are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic of an HVAC system, according to one or more embodiments;

FIG. 2 is a simplified block diagram of an HVAC system 200, according to one or more embodiments; and

FIG. 3 is a block diagram of a controller, according to one or more embodiments.

### DETAILED DESCRIPTION

The present disclosure describes an HVAC system having multiple inverters. The use of multiple inverters instead of a single inverter allows the HVAC system to operate at full load without the high risk of the inverter overheating while increasing the performance of the HVAC system.

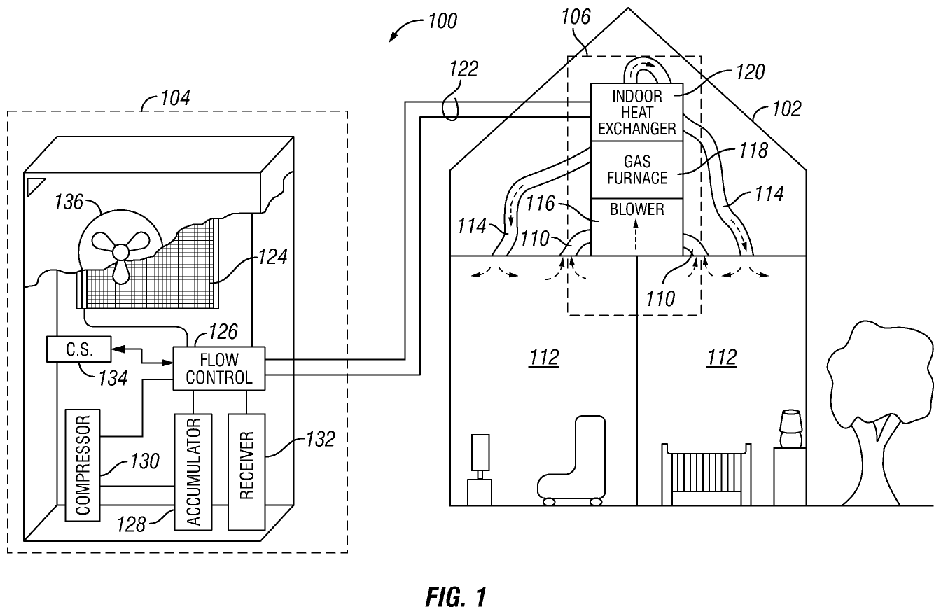

Turning now the figures, FIG. 1 illustrates a schematic of an HVAC system 100 in accordance with one embodiment. As depicted, the HVAC system 100 heats and cools a residential structure 102. However, the concepts disclosed herein are applicable to numerous of heating and cooling situations, which include industrial and commercial settings.

The HVAC system 100 divides into two primary portions: The outdoor unit 104, which comprises components for transferring heat with the environment outside the structure 102; and the indoor unit 106, which comprises components for transferring heat with the air inside the structure 102. To heat or cool the illustrated structure 102, the indoor unit 106 draws ambient indoor air via returns 110, passes that air over one or more heating/cooling elements (i.e., sources of heating or cooling), and then routes that conditioned air, whether heated or cooled, back to the various climate-controlled spaces 112 through ducts or ductworks 114—which are relatively large pipes that may be rigid or flexible. A blower 116 provides the motivational force to circulate the ambient air through the returns 110 and the ducts 114. Additionally, although a split system is shown in FIG. 1, the disclosed embodiments can be equally applied to the packaged or other types of system configurations.

As shown, the HVAC system 100 is a “dual-fuel” system that has multiple heating elements, such as an electric heating element or a gas furnace 118. The gas furnace 118 located downstream (in relation to airflow) of the blower 116 combusts natural gas to produce heat in furnace tubes (not shown) that coil through the gas furnace 118. These furnace tubes act as a heating element for the ambient indoor air being pushed out of the blower 116, over the furnace tubes, and into the ducts 114. However, the gas furnace 118 is generally operated when robust heating is desired. During conventional heating and cooling operations, air from the blower 116 is routed over an indoor heat exchanger 120 and into the ductwork 114. The blower 116, the gas furnace 118, and the indoor heat exchanger 120 may be packaged as an integrated air handler unit, or those components may be modular. In other embodiments, the positions of the gas furnace 118, the indoor heat exchanger 120, and the blower 116 can be reversed or rearranged.

In at least one embodiment, the indoor heat exchanger 120 acts as a heating or cooling means that adds or removes heat from the structure, respectively, by manipulating the pressure and flow of refrigerant circulating within and between the indoor and outdoor units via refrigerant lines 122. In another embodiment, the refrigerant could be circulated to only cool (i.e., extract heat from) the structure, with heating provided independently by another source, such as, but not limited to, the gas furnace 118. In other embodiments, there may be no heating of any kind. HVAC systems 100 that use refrigerant to both heat and cool the structure 102 are often described as heat pumps, while HVAC systems 100 that use refrigerant only for cooling are commonly described as air conditioners.

Whatever the state of the indoor heat exchanger 120 (i.e., absorbing or releasing heat), the outdoor heat exchanger 124 is in the opposite state. More specifically, if heating is desired, the illustrated indoor heat exchanger 120 acts as a condenser, aiding transition of the refrigerant from a high-pressure gas to a high-pressure liquid and releasing heat in the process. The outdoor heat exchanger 124 acts as an evaporator, aiding transition of the refrigerant from a low-pressure liquid to a low-pressure gas, thereby absorbing heat from the outdoor environment. If cooling is desired, the outdoor unit 104 has flow control devices 126 that reverse the flow of the refrigerant, allowing the outdoor heat exchanger 124 to act as a condenser and allowing the indoor heat exchanger 120 to act as an evaporator. The flow control devices 126 may also act as an expander to reduce the pressure of the refrigerant flowing therethrough. In other embodiments, the expander may be a separate device located in either the outdoor unit 104 or the indoor unit 106. To facilitate the exchange of heat between the ambient indoor air and the outdoor environment in the described HVAC system 100, the respective heat exchangers 120, 124 have tubing that winds or coils through heat-exchange surfaces, to increase the surface area of contact between the tubing and the surrounding air or environment.

The illustrated outdoor unit 104 may also include an accumulator 128 that helps prevent liquid refrigerant from reaching the inlet of a compressor 130. The outdoor unit 104 may include a receiver 132 that helps to maintain sufficient refrigerant charge distribution in the HVAC system 100. The size of these components is often defined by the amount of refrigerant employed by the HVAC system 100.

The compressor 130 receives low-pressure gas refrigerant from either the indoor heat exchanger 120 if cooling is desired or from the outdoor heat exchanger 124 if heating is desired. The compressor 130 then compresses the gas refrigerant to a higher pressure based on a compressor volume ratio, namely the ratio of a discharge volume, the volume of gas outputted from the compressor 130 once compressed, to a suction volume, the volume of gas inputted into the compressor 130 before compression, and other operating conditions. In at least one embodiment, the compressor is a multi-stage compressor that can transition between at least two volume ratios depending on whether heating or cooling is desired. In other embodiments, the HVAC system 100 may be configured to only cool or only heat, the compressor 130 may be a single stage compressor having only a single volume ratio, the compressor may be a multi-stage compressor, or the HVAC system 100 may include a tandem compressor system.

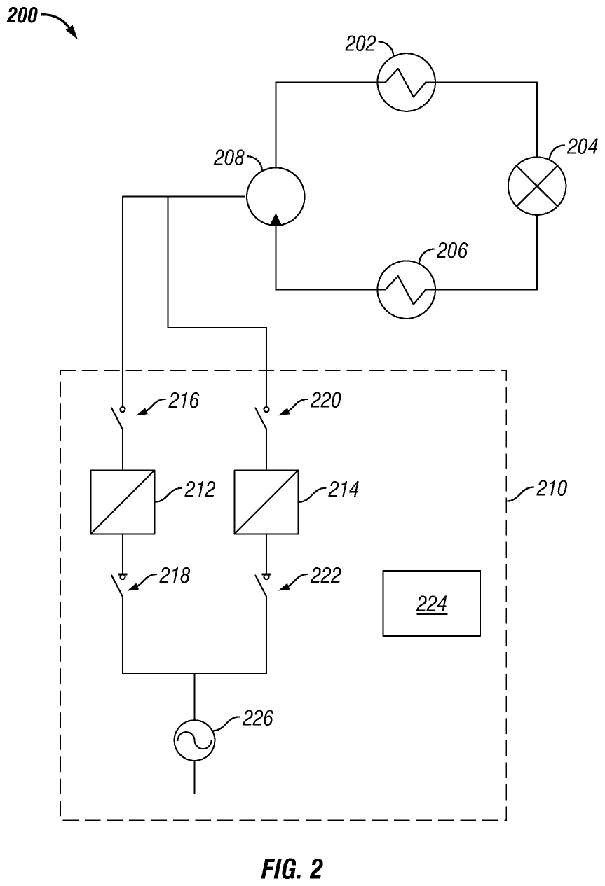

The compressor 130 receives electrical power from a control system 134 that includes an inverter system, as described in more detail below with reference to FIG. 2, which converts the AC power received by the HVAC system 100 to DC power for use by the compressor 130. The control system 134 controls the speed of the compressor 130, as well as the switching between compressor stages for multi-stage compressors, based on the required heating or cooling that must be provided by the HVAC system, i.e., the load on the HVAC system 100. In some embodiments, the control system may also control the speed of a fan 136 that blows air across the heat exchanger 124.

In at least one embodiment, the control system 124 is in electronic communication with a second control system (not shown) that determines system load. In other embodiments, the control system may determine the load on the HVAC system 100 based on user input, such as a desired temperature, desired temperature range, or a desired humidity, and/or data from sensors placed through the HVAC system 100. The data measured by the sensors may include, but is not limited to, the temperature within the structure 102, the humidity within the structure 102, the temperature outside of the structure 102, the humidity outside of the structure 102, and refrigerant pressure within the HVAC system.

The speed of the compressor 130 and fan 136 may be adjusted by either supplying a variable DC voltage to the compressor 130 and the fan 136 or by using pulse width modulation (“PWM”) of the DC power supplied to the compressor 130 and the fan 136. Both methods of adjusting the speed of the compressor 130 increase the amount of power that must be delivered by the inverter system as the load on the HVAC system 100 increases, until a full system load, i.e., the maximum heating or cooling that can be supplied by the HVAC system 100, and associated maximum power requirement, is reached. In at least one embodiment, the maximum system load occurs at about 52° C. (125° F.) ambient temperature. In other embodiments, the maximum system load may be reached at a temperature above 52° C. (125° F.) or at a temperature below 52° C. (125° F., depending on the specific system and the expected environment.

Referring now to FIG. 2, FIG. 2 is a simplified block diagram of an HVAC system 200. The HVAC system 200 includes a first heat exchanger 202, an expansion device 204, a second heat exchanger 206, and a compressor 208. Additionally, the first heat exchanger 202 may be either an indoor heat exchanger or an outdoor heat exchanger and the second heat exchanger 206 may be either an indoor heat exchanger or an outdoor heat exchanger, depending on the configuration of the HVAC system 200.The HVAC system 200 may also include the equipment shown in FIG. 1 and function as discussed above with reference to FIG. 1. Accordingly, the function of first heat exchanger 202, the expansion device 204, the second heat exchanger 206, and the compressor 208 will not be discussed in detail except as necessary for the understanding of the HVAC system 200 shown in FIG. 2.

As shown in FIG. 2, high-pressure refrigerant flows from the compressor 208 to the first heat exchanger 202, where it is condensed. The high-pressure liquid refrigerant then flows to the expansion device 204, where it is expanded to low-pressure refrigerant. The low-pressure refrigerant is then evaporated in the second heat exchanger 206 and the low-pressure vapor flows into the compressor 208 as a vapor, to begin the cycle again.

As discussed above, it is necessary to increase the speed of the compressor 208 as the load on the HVAC system 200 increases to increase the heating or cooling supplied by the HVAC system 200. Conversely, the speed of the compressor is decreased as the heating or cooling requirements on the HVAC system 200 decrease. The speed of the compressor 208 is controlled via a control system 210. The control system 210 adjusts the speed of the compressor 208 by varying the voltage supplied to the compressor 208 or by using PWM of the DC power supplied to the compressor 208. This methodology can also be applied to both the indoor blower and the outdoor fan for air-based systems or applied to liquid pumps for liquid-based secondary loops. In such embodiments, a separate inverter system including both a fixed inverter and a variable speed inverter may supply power to the fans or pumps.

The control system 210 includes a variable speed inverter 212, i.e., an inverter that delivers a variable amount of DC power, a fixed inverter 214, i.e., an inverter that delivers a fixed amount of DC power corresponding to the required DC power to operating the compressor at full load, if required, multiple switches 216, 218, 220, 222 to direct power through one of the inverters 212, 214, and a controller 224. The controller 224 is in electronic communication with the variable speed inverter 212 and the switches 216, 218, 220, 222, and is programmed to operate the switches 216, 218, 220, 222 and adjust the DC power delivered by the variable speed inverter 212 based on the load on the HVAC system 200. In other embodiments, the switches 218, 222 associated with supplying AC power may be replaced by a switch that supplies AC power to one of either the variable speed inverter 212 or the fixed inverter 214 and/or the switches 216, 220 associated with supplying DC power may be replaced by a switch that supplies DC power to the compressor 208 from either the variable speed inverter 212 or the fixed inverter 214. The ability to adjust the amount of DC power delivered to the compressor 208 reduces the cost of operating the HVAC system, since less power can be supplied to the compressor 208 when less than the full cooling or heating capacity of the HVAC system 200 is required. In at least one embodiment, the compressor 208 is a tandem compressor system including a fixed speed compressor and a variable speed compressor. In such embodiments, the fixed inverter 214 may supply power to the fixed speed compressor and the variable speed inverter 212 may supply power to the variable speed compressor.

When the HVAC system 200 is not at full load or about full load, i.e., within 5% of full load, the controller 224 opens the switch 222 supplying AC power from the AC power source 226 to the fixed inverter 214 and the switch 220 supplying DC power from the fixed inverter 214 to the compressor 208, while closing the switch 218 supplying AC power from the AC power source 226 to the variable speed inverter 212 and the switch 216 supplying DC power from the variable speed inverter 212 to the compressor 208. This configuration allows the controller 224 to adjust the output of the variable speed inverter 212 based on the system load.

Once the HVAC system 200 reaches about full load, the controller 224 closes the switch 222 supplying AC power from the AC power source 226 to the fixed inverter 214 and the switch 220 supplying DC power from the fixed inverter 214 to the compressor 208, while opening the switch 218 supplying AC power from the AC power source 226 to the variable speed inverter 212 and the switch 216 supplying DC power from the variable speed inverter 212 to the compressor 208. This allows the fixed inverter 214 to supply the required power to operate the compressor 208 at full load. As the fixed inverter 214 outputs a fixed amount of DC power, the fixed inverter 214 is typically 3% to 5% more efficient than the variable speed inverter 212 at delivering DC power when the HVAC system 200 is operating under a full load. Further, operating the fixed inverter 214 instead of the variable speed inverter 212 greatly reduces the risk that the variable speed inverter 212 overheating, subsequently resulting in the HVAC system 200 to shut down and potentially cause damage to the variable speed inverter 212. Once the load on the HVAC system 200 drops below about full load, the controller 224 opens the switches 220, 222 associated with the fixed inverter 214 and closes the switches 216, 218 associated with the variable speed inverter 212 to allow the variable speed inverter 212 to supply DC power to the compressor 208.

Although the variable speed inverter 212, fixed inverter 214, switches 216, 218, 220, 222, and controller 224 are shown as part of a single control system 210 in FIG. 2, this is not indicative of their actual locations within the HVAC system 200. The variable speed inverter 212, fixed inverter 214, switches 216, 218, 220, 222, and controller 224 may be separated and placed as necessary based on the physical requirements of the HVAC system 200 and the specific equipment that makes up the HVAC system 200. Further, the controller 224 may be made up of any number of controllers that, in combination, control the operation of the switches 216, 218, 220, 222 and variable speed inverter 212 as described above.

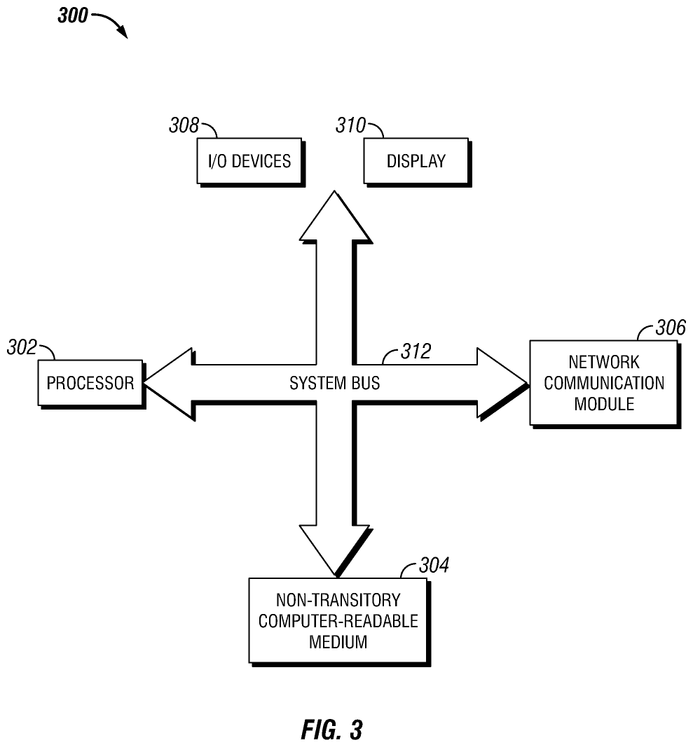

FIG. 3 is a block diagram of a controller 300 that can be used to control the switches and inverter of a control system, as described above. The controller 300 includes at least one processor 302, a non-transitory computer readable medium 304, an optional network communication module 306, optional input/output devices 308, and an optional display 310 all interconnected via a system bus 312. In at least one embodiment, the input/output device 308 and the display 310 may be combined into a single device, such as a touch-screen display. Further, the display 310 may also include a temperature sensor that monitors the temperature within a structure. Software instructions executable by the processor 302 for implementing software instructions stored within the controller 300 in accordance with the illustrative embodiments described herein, may be stored in the non-transitory computer readable medium 304 or some other non-transitory computer-readable medium.

Although not explicitly shown in FIG. 3, it will be recognized that the controller 300 may be connected to one or more public and/or private networks via appropriate network connections. It will also be recognized that software instructions may also be loaded into the non-transitory computer readable medium 304 from an appropriate storage media or via wired or wireless means.

Further examples include:

Example 1 is a control system for an HVAC system. The control system includes a variable speed inverter, a fixed inverter, switches, and a first controller. The switches are operable to allow AC power to be supplied to one of either the variable speed inverter or the fixed inverter and to allow DC power to be supplied from the one of either the variable speed inverter or the fixed inverter. The first controller is in electronic communication with the switches and includes a processor. The processor is programmed to operate the switches to allow AC power to be supplied to one of either the variable speed inverter or the fixed inverter and to deliver DC power from the one of either the variable speed inverter or fixed inverter.

In Example 2, the embodiments of any preceding paragraph or combination thereof further include wherein the variable speed inverter and the fixed inverter are operable to deliver DC power to a compressor of the HVAC system.

In Example 3, the embodiments of any preceding paragraph or combination thereof further include wherein the variable speed inverter and the fixed inverter are operable to deliver DC power to a fan of the HVAC system.

In Example 4, the embodiments of any preceding paragraph or combination thereof further include a second controller in electronic communication with the first controller and operable to determine a load on the HVAC system. The processor is further programmed to operate the switches to allow AC power to be supplied to the variable speed inverter and deliver DC power from the variable speed inverter if the load is below about a full load for the HVAC system. The processor is also programmed to operate the switches to allow AC power to be supplied to the fixed inverter and deliver DC power from the fixed inverter if the load is at about the full load.

In Example 5, the embodiments of any preceding paragraph or combination thereof further include wherein the first controller is in electronic communication with the variable speed inverter and the processor is further programmed to adjust an amount of DC power delivered by the variable speed inverter based on the load.

In Example 6, the embodiments of any preceding paragraph or combination thereof further include sensors in electronic communication with the first controller, wherein each sensor is operable to measure at least one of temperature or pressure. The processor is further programmed to determine a load on the HVAC system based on the measurements from the sensors. The processor is also programmed to operate the switches to allow AC power to be supplied to the variable speed inverter and deliver DC power from the variable speed inverter if the load is below about a full load for the HVAC system. The processor is further programmed to operate the switches to allow AC power to be supplied to the fixed inverter and deliver DC power from the fixed inverter if the load is at about the full load.

In Example 7, the embodiments of any preceding paragraph or combination thereof further include wherein the first controller is in electronic communication with the variable speed inverter and the processor is further programmed to adjust an amount of DC power delivered by the variable speed inverter based on the load.

Example 8 is an HVAC system for use with a refrigerant. The HVAC system includes a compressor, a condenser, an expansion device, an evaporator, a variable speed inverter, and a fixed inverter. The compressor is operable to compress the refrigerant. The condenser is positioned downstream of the compressor and operable to condense the refrigerant. The expansion device is positioned downstream of the condenser and operable to reduce a pressure of the refrigerant flowing therethrough. The evaporator is positioned downstream of the expansion device and upstream of the compressor. The evaporator is operable to vaporize the refrigerant from the expansion device. The variable speed inverter is operable to deliver DC power to the compressor. The fixed inverter is operable to deliver DC power to the compressor.

In Example 9, the embodiments of any preceding paragraph or combination thereof further include a fan operable to flow air over one of either the condenser or the evaporator, wherein the variable speed inverter and the fixed inverter are operable to deliver DC power to the fan.

In Example 10, the embodiments of any preceding paragraph or combination thereof further include a first control system including switches and a controller. The switches are operable to allow AC power to be supplied to one of either the variable speed inverter or the fixed inverter and to allow DC power to be supplied from the one of either the variable speed inverter or the fixed inverter. The controller is in electronic communication with the switches and includes a processor. The processor is programmed to operate the switches to allow AC power to be supplied to one of either the variable speed inverter or the fixed inverter and to deliver DC power from the one of either the variable speed inverter or fixed inverter.

In Example 11, the embodiments of any preceding paragraph or combination thereof further include a second control system in electronic communication with the controller and operable to determine a load on the HVAC system. The processor is further programmed to operate the switches to allow AC power to be supplied to the variable speed inverter and deliver DC power from the variable speed inverter if the load is below about a full load for the HVAC system. The processor is also programmed to operate the switches to allow AC power to be supplied to the fixed inverter and deliver DC power from the fixed inverter if the load is at about the full load.

In Example 12, the embodiments of any preceding paragraph or combination thereof further include wherein the controller is in electronic communication with the variable speed inverter and the processor is further programmed to adjust an amount of DC power delivered by the variable speed inverter based on the load.

In Example 13, the embodiments of any preceding paragraph or combination thereof further include sensors in electronic communication with the controller, wherein each sensor is operable to measure at least one of temperature or pressure. The processor is further programmed to determine a load on the HVAC system based on the measurements from the sensors. The processor is also programmed to operate the switches to allow AC power to be supplied to the variable speed inverter and deliver DC power from the variable speed inverter if the load is below about a full load for the HVAC system. The processor is further programmed to operate the switches to allow AC power to be supplied to the fixed inverter and deliver DC power from the fixed inverter if the load is at about the full load.

In Example 14, the embodiments of any preceding paragraph or combination thereof further include wherein the controller is in electronic communication with the variable speed inverter and the processor is further programmed to adjust an amount of DC power delivered by the variable speed inverter based on the load.

Example 15 is an HVAC system for use with a refrigerant. The HVAC system includes a compressor, a condenser, an expansion device, an evaporator, a first variable speed inverter, a first fixed inverter, and a first control system. The compressor is operable to compress the refrigerant. The condenser is positioned downstream of the compressor and operable to condense the refrigerant. The expansion device is positioned downstream of the condenser and operable to reduce a pressure of the refrigerant flowing therethrough. The evaporator is positioned downstream of the expansion device and upstream of the compressor. The evaporator is operable to vaporize the refrigerant from the expansion device. The first variable speed inverter is operable to deliver DC power to the compressor. The first fixed inverter is operable to deliver DC power to the compressor. The first control system includes switches and a controller. The switches are operable to allow AC power to be supplied to one of either the first variable speed inverter or the first fixed inverter and to allow DC power to be supplied from the one of either the first variable speed inverter or the first fixed inverter. The controller is in electronic communication with the switches and includes a processor. The processor is programmed to operate the switches to allow AC power to be supplied to the first variable speed inverter and deliver DC power from the first variable speed inverter if a load on the HVAC system is below about a full load for the HVAC system. The processor is further programmed to operate the switches to allow AC power to be supplied to the first fixed inverter and deliver DC power from the first fixed inverter if the load is at about the full load.

In Example 16, the embodiments of any preceding paragraph or combination thereof further include wherein the controller is in electronic communication with the first variable speed inverter and the processor is further programmed to adjust an amount of DC power delivered by the first variable speed inverter to the compressor based on the load.

In Example 17, the embodiments of any preceding paragraph or combination thereof further include a fan operable to flow air over one of either the condenser or the evaporator, a second fixed inverter, and a second variable speed inverter. Both the second fixed inverter and the second variable speed inverter are operable to deliver DC power to a fan.

In Example 18, the embodiments of any preceding paragraph or combination thereof further include wherein the controller is in electronic communication with the first variable speed inverter and the second variable speed inverter, and the processor is further programmed to adjust an amount of DC power delivered by the first variable speed inverter to the compressor and the amount of power delivered by the second variable speed inverter to the fan based on the load.

In Example 19, the embodiments of any preceding paragraph or combination thereof further include sensors in electronic communication with the controller, wherein each sensor is operable to measure at least one of temperature or pressure and the processor is further programmed to determine the load based on the measurements from the sensors.

In Example 20, the embodiments of any preceding paragraph or combination thereof further include a second control system in electronic communication with the controller and operable to determine a load on the HVAC system.

Certain terms are used throughout the description and claims to refer to particular features or components. As one skilled in the art will appreciate, different persons may refer to the same feature or component by different names. This document does not intend to distinguish between components or features that differ in name but not function.

For the embodiments and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of the anomalies. Such a user interface can be operated in conjunction with the communications unit and the bus. Various components of the system can be integrated such that processing identical to or similar to the processing schemes discussed with respect to various embodiments herein can be performed.

In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A control system for a heating, ventilation, and air-conditioning (“HVAC”) system, the control system comprising:
a variable speed inverter;
a fixed inverter;
switches operable to allow AC power to be supplied to one of either the variable speed inverter or the fixed inverter and to allow DC power to be supplied from the one of either the variable speed inverter or the fixed inverter; and
a first controller in electronic communication with the switches and comprising a processor, the processor programmed to operate the switches to allow AC power to be supplied to one of either the variable speed inverter or the fixed inverter and to deliver DC power from the one of either the variable speed inverter or fixed inverter.

2. The control system of claim 1, wherein the variable speed inverter and the fixed inverter are operable to deliver DC power to a compressor of the HVAC system.

3. The control system of claim 1, wherein the variable speed inverter and the fixed inverter are operable to deliver DC power to a fan of the HVAC system.

4. The control system of claim 1, further comprising a second controller in electronic communication with the first controller and operable to determine a load on the HVAC system, wherein the processor is further programmed to:
operate the switches to allow AC power to be supplied to the variable speed inverter and deliver DC power from the variable speed inverter if the load is below about a full load for the HVAC system; and
operate the switches to allow AC power to be supplied to the fixed inverter and deliver DC power from the fixed inverter if the load is at about the full load.

5. The control system of claim 4, wherein the first controller is in electronic communication with the variable speed inverter and the processor is further programmed to adjust an amount of DC power delivered by the variable speed inverter based on the load.

6. The control system of claim 1, further comprising sensors in electronic communication with the first controller, wherein each sensor is operable to measure at least one of temperature or pressure and the processor is further programmed to:
determine a load on the HVAC system based on the measurements from the sensors;
operate the switches to allow AC power to be supplied to the variable speed inverter and deliver DC power from the variable speed inverter if the load is below about a full load for the HVAC system; and
operate the switches to allow AC power to be supplied to the fixed inverter and deliver DC power from the fixed inverter if the load is at about the full load.

7. The control system of claim 6, wherein the first controller is in electronic communication with the variable speed inverter and the processor is further programmed to adjust an amount of DC power delivered by the variable speed inverter based on the load.

8. An HVAC system for use with a refrigerant, the HVAC system comprising:
a compressor operable to compress the refrigerant;
a condenser positioned downstream of the compressor; the condenser operable to condense the refrigerant;
an expansion device positioned downstream of the condenser, the expansion device operable to reduce a pressure of the refrigerant flowing therethrough;
an evaporator positioned downstream of the expansion device and upstream of the compressor, the evaporator operable to vaporize the refrigerant from the expansion device;
a variable speed inverter operable to deliver DC power to the compressor; and
a fixed inverter operable to deliver DC power to the compressor.

9. The HVAC system of claim 8, further comprising a fan operable to flow air over one of either the condenser or the evaporator, wherein the variable speed inverter and the fixed inverter are operable to deliver DC power to the fan.

10. The HVAC system of claim 8, further comprising a first control system comprising:
switches operable to allow AC power to be supplied to one of either the variable speed inverter or the fixed inverter and to allow DC power to be supplied from the one of either the variable speed inverter or the fixed inverter; and
a controller in electronic communication with the switches and comprising a processor, the processor programmed to operate the switches to allow AC power to be supplied to one of either the variable speed inverter or the fixed inverter and to deliver DC power from the one of either the variable speed inverter or fixed inverter.

11. The HVAC system of claim 10, further comprising a second control system in electronic communication with the controller and operable to determine a load on the HVAC system, wherein the processor is further programmed to:
operate the switches to allow AC power to be supplied to the variable speed inverter and deliver DC power from the variable speed inverter if the load is below about a full load for the HVAC system; and
operate the switches to allow AC power to be supplied to the fixed inverter and deliver DC power from the fixed inverter if the load is at about the full load.

12. The HVAC system of claim 11, wherein the controller is in electronic communication with the variable speed inverter and the processor is further programmed to adjust an amount of DC power delivered by the variable speed inverter based on the load.

13. The HVAC system of claim 10, further comprising sensors in electronic communication with the controller, wherein each sensor is operable to measure at least one of temperature or pressure and the processor is further programmed to:
determine a load on the HVAC system based on the measurements from the sensors;
operate the switches to allow AC power to be supplied to the variable speed inverter and deliver DC power from the variable speed inverter if the load is below about a full load for the HVAC system; and
operate the switches to allow AC power to be supplied to the fixed inverter and deliver DC power from the fixed inverter if the load is at about the full load.

14. The HVAC system of claim 13, wherein the controller is in electronic communication with the variable speed inverter and the processor is further programmed to adjust an amount of DC power delivered by the variable speed inverter based on the load.

15. An HVAC system for use with a refrigerant, the HVAC system comprising:
a compressor operable to compress the refrigerant;
a condenser positioned downstream of the compressor; the condenser operable to condense the refrigerant;
an expansion device positioned downstream of the condenser, the expansion device operable to reduce a pressure of the refrigerant flowing therethrough;
an evaporator positioned downstream of the expansion device and upstream of the compressor, the evaporator operable to vaporize the refrigerant from the expansion device;
a first variable speed inverter operable to deliver DC power to the compressor;
a first fixed inverter operable to deliver DC power to the compressor; and
a first control system comprising:
switches operable to allow AC power to be supplied to one of either the first variable speed inverter or the first fixed inverter and to allow DC power to be supplied from the one of either the first variable speed inverter or the first fixed inverter; and
a controller in electronic communication with the switches and comprising a processor, the processor programmed:
operate the switches to allow AC power to be supplied to the first variable speed inverter and deliver DC power from the first variable speed inverter if a load on the HVAC system is below about a full load for the HVAC system; and
operate the switches to allow AC power to be supplied to the first fixed inverter and deliver DC power from the first fixed inverter if the load is at about the full load.

16. The HVAC system of claim 15, wherein the controller is in electronic communication with the first variable speed inverter and the processor is further programmed to adjust an amount of DC power delivered by the first variable speed inverter to the compressor based on the load.

17. The HVAC system of claim 15, further comprising:
a fan operable to flow air over one of either the condenser or the evaporator;
a second fixed inverter;
a second variable speed inverter; and
wherein both the second fixed inverter and the second variable speed inverter are operable to deliver DC power to a fan.

18. The HVAC system of claim 17, wherein the controller is in electronic communication with the first variable speed inverter and the second variable speed inverter, and the processor is further programmed to adjust an amount of DC power delivered by the first variable speed inverter to the compressor and the amount of power delivered by the second variable speed inverter to the fan based on the load.

19. The HVAC system of claim 15, further comprising sensors in electronic communication with the controller, wherein each sensor is operable to measure at least one of temperature or pressure and the processor is further programmed to determine the load based on the measurements from the sensors.

20. The system of claim 15, further comprising a second control system in electronic communication with the controller and operable to determine a load on the HVAC system.
